(19) United States
(12) Patent Application Publication
(10) Pub. No.: US 2023/0075347 A1
(43) Pub. Date: Mar. 9, 2023

(54) SETTING DESIRED BROWNING ON A DOMESTIC COOKING APPLIANCE

(71) Applicant: BSH Hausgeräte GmbH, Munich (DE)

(72) Inventors: Julien Adam, Lingolsheim (FR); Kadir Nigar, Strasbourg (DE)

(21) Appl. No.: 17/800,906

(22) PCT Filed: Feb. 25, 2021
(86) PCT No.: PCT/EP2021/054664

§ 371 Date: Aug. 19, 2022

(30) Foreign Application Priority Data
Mar. 12, 2020 (EP) 20290028.8

(51) Int. Cl. A47J 36/32; G06F 3/0484; G06V 20/68; G06V 10/74

(52) U.S. Cl. CPC A47J 36/32; G06F 3/0484; G06V 20/68; G06V 10/74; G06F 3/0488

(57) ABSTRACT

In a method for setting a desired degree of browning of food to be cooked, an image from a cooking chamber of a household cooking appliance containing food to be cooked is recorded and the image is displayed on a screen. A user-selectable image measurement region is defined in the displayed image and a desired degree of browning is ascertained for the selected image measurement region.

The invention relates to a method for setting a desired degree of browning, having the following steps: recording an image from a cooking chamber of a household cooking appliance; defining an image measurement region in the displayed image; and ascertaining a desired degree of browning for the selected image measurement region. The invention also relates to an apparatus for carrying out the method, having a household cooking appliance with a cooking chamber, at least one camera directed into the cooking chamber, at least one screen on which it is possible to display images recorded by the at least one camera, at least one operator interface and a data processing facility for carrying out the cooking procedure taking account of the desired degree of browning. The invention is particularly advantageously applicable to baking ovens.

EP 3 477 206 A1 discloses a cooking appliance comprising: a cooking chamber, an image generation apparatus for detecting an image of a foodstuff within the cooking chamber; a data processing apparatus which communicates with the image generation apparatus and comprises a software module which is configured to receive the detected image from the image generation apparatus and to calculate a degree of browning, and an operator interface which is configured to display a visual scale of the degree of browning. In one embodiment, the cooking appliance comprises a selection facility which is configured to enable a user to set a desired degree of browning for the food.

US 20130092145 A1 discloses an oven comprising a cooking chamber which is configured to receive a food product, an operator interface which is configured to display information in conjunction with processes used for cooking, a first and a second energy source as well as a cooking control system. The first energy source delivers primary heat and the second energy source delivers secondary heat for the food product. During normal operation the cooking control system can be coupled with the first and the second energy source. The cooking control system can contain a processing circuit which is configured to enable an operator to make a browning control selection by way of the operator interface, by providing operator instructions to a selected control console which is displayed on the operator interface. The selected control console can be selected on the basis of a cooking mode of the oven. The selection of the browning control system can provide control parameters in order to apply the heat directly onto the food product via the second energy source. In one embodiment, the cooking mode is one mode from a first mode, in which the operator can select several of the control parameters including air temperature, air speed and time, and from a second mode, in which the operator can select a degree of browning, wherein the control parameters are then determined automatically on the basis of the selected degree of browning.

WO 2009/026895 A2 discloses a method for adjusting a working schedule to proceed in an interior of a cooking appliance, comprising at least one cooking program and/or at least one cleaning program, in which at least one parameter of a plurality of parameters or at least one display and operating facility can be adjusted, wherein the parameter, the adjustable values of the parameter and the adjusted value are visualized at least for a time on the display and operating facility. In one embodiment, the visualization of a plurality of outer degrees of cooking in order to adjust the other first parameter for the food to be cooked or the display of a plurality of browning adjustment ranges of a scale of browning can take place, wherein the number and/or colors of the browning adjustment ranges is or are preferably determined as a function of the selected type of food to be cooked, the selected part, the place of installation of the cooking appliance and/or the operating language of the cooking appliance.

DE 10 2016 215 550 A1 discloses a method for ascertaining a degree of browning of food to be cooked in a cooking chamber of a household cooking appliance, which household cooking appliance has a camera directed into the cooking chamber and a light source for illuminating the cooking chamber, and wherein a reference image is recorded by means of the camera, a first measuring image is recorded with a first brightness of the light source, a second measuring image is recorded with a second brightness of the light source, a differential image is generated from the first measuring image and the second measuring image and the differential image is compared with the reference image.

With the known browning measurements, it is automatically determined which region of the recorded image is to be used as an image measurement region or “reference region” in order to determine the degree of browning. This is known as a “classification” or “segmentation” problem and poses one of the greatest challenges for automatic browning recognition. Until now, in most cases complex AI (Artificial Intelligence) algorithms based on machine learning were used for this purpose. Such algorithms are difficult to develop and require a high computing power. With implementation in the household cooking appliance, this in turn results in high costs for the associated data processing facility. But even with a high outlay for carrying out such AI algorithms, the determination of a suitable image measurement region is frequently unsatisfactory, particularly with complex (especially inhomogeneous) food to be cooked. Therefore by using AI algorithms to determine the image measurement region, the cooking results are also frequently not browned to the user's satisfaction.

It is the object of the present invention to overcome at least partially the disadvantages of the prior art and in particular to provide an improved possibility of achieving a desired degree of browning of food to be cooked during a cooking process.

This object is achieved according to the features of the independent claims. Advantageous embodiments form the subject matter of the dependent claims, the description and the drawings.

The object is achieved by a method for setting a desired degree of browning of food to be cooked, having the following steps:

recording an image from a cooking chamber of a household cooking appliance containing food to be cooked;

displaying the image on a screen; and

defining a user-selectable image measurement region in the displayed image; and

ascertaining a desired degree of browning for the selected image measurement region.

As a result of the image measurement region used to determine an actual degree of browning being selectable or ascertainable by a user, the advantage is achieved that the degree of browning is determined in a targeted manner on the basis of that food to be cooked and/or on the basis of that region which is decisive or most important for the user in order to reach a desired cooking result. In particular, a specific food to be cooked or a specific region of the food to be cooked can therefore also be reliably selected in a targeted manner by the user, if

the food to be cooked has an inhomogeneous color distribution and/or indicates a locally noticeably different browning profile, e.g. marble cakes, pizza with several toppings, stir-fried vegetables etc.;

the food to be cooked has different food or food components, e.g. chicken with French fries;

the food has a complex shape so that it is illuminated to differing degrees, e.g. bread;

a food base is visible, which is browned during a cooking process, e.g. baking paper and/or

a colored (in particular brown to black) container for food to be cooked such as a baking tin etc. is used

or another complex food to be cooked is present.

As a result it is in turn possible to dispense with a developmentally and computationally complex and still frequently fault-prone automatic determination of the image measurement region. For instance, in the case of a chicken with French fries the user can determine whether a cooking process is to be controlled on the basis of the degree of browning of the chicken or of the French fries and the user can place the image measurement region accurately on the chicken or the French fries. The idea underlying the method is therefore to allow the user to decide where the degree of browning is to be determined in the recorded image.

The image can be recorded with the aid of a camera, possibly with the aid of a camera from a group of several available cameras, which record the food to be cooked from different angles, for instance.

The definition of the user-selectable image measurement region in the displayed image therefore comprises the possibility that a user can himself ascertain the image measurement region which is used to determine the degree of browning.

The desired degree of browning for the selected image measurement region can be defined by the user and/or automatically, e.g. on the basis of desired degrees of browning or calculated desired degrees of browning stored in a database. For instance, the user can set the desired degree of browning by way of a percentage scale or a color scale, e.g. by means of what is known as a slider. The automatic ascertainment can take place for instance with the aid of cooking programs or with the aid of values stored previously by the user. Generally methods known for this can be applied in order to determine the desired degree of browning.

The step of

carrying out a cooking process by taking into account the desired degree of browning

can accompany the method. The method can then also be considered as a method for operating a household cooking appliance or as a method for carrying out a cooking process or cooking procedure. The cooking process taking into account the desired degree of browning can be carried out according to any known and suitable method and uses the user-selected image measurement region as a reference region. In particular, in order to determine how the degree of browning is determined in the image measurement region, when the actual degree of browning has reached the desired degree of browning and which action is then triggered (e.g. the cooking process is stopped, the cooking chamber is cooled, a message is output to the user etc.), it is then possible to revert back to known methods.

In one embodiment, the step of defining the image measurement region comprises a user-led positioning of the image measurement region by way of the screen. As a result, the image measurement region can be ascertained or defined particularly easily. In this embodiment, the user can at least displace the image measurement region on the screen (in the x and y direction). The image measurement region can be predefined for instance as a cursor or cursor window/cursor region which can be displaced over the screen.

In one embodiment, the user-led definition of the image measurement region comprises a touch-led and/or control panel-led positioning of the image measurement region over the screen. This significantly facilitates a positioning of the image measurement region. With the touch-led positioning, the image measurement region is positioned by touching a touch-sensitive screen, e.g. by a user using his finger to tap on the screen at the point at which the image measurement region is to be positioned, by pulling the cursor/cursor region to the desired position etc. The cursor/cursor region can be assumed to be the image measurement region automatically or only after user confirmation. With the control panel-led positioning, the cursor can be moved by means of a control panel (e.g. by moving a joystick, actuating cursor keys etc.) on the screen. Here the screen does not need to be a touch-sensitive screen.

In one embodiment, the image measurement region can be varied by the user, e.g. in respect of its shape and/or size. As a result, the image measurement region can be adjusted even more precisely to a user's requirements. For instance, a square or round image measurement region can be reduced or increased in size by a user, e.g. by a two-finger movement (“pinching”). The shape of the image measurement region can also be changed, e.g. an edge ratio of a rectangle, a shape from oval to circular etc.

In one embodiment, in order to define the image measurement region,

a pattern region comprising this image region is determined automatically at an image region selected by the user and

the pattern region is assumed to be the image measurement region.

This achieves the advantage that image measurement regions with complicated shapes or contours can also be easily defined or ascertained by a user. The pattern region can be assumed to be the image measurement region automatically or only after user confirmation. This embodiment manages without complicated AI algorithms, but can use methods of pattern recognition, for instance, which are known from the field of image processing and can be implemented comparatively easily. For instance, a user can select an object (e.g. a chicken) identifiable to him in the recorded image by tapping on the appropriate touch-sensitive screen, whereupon the contour of the chicken in the image is determined by means of pattern recognition. The user can then confirm or reject this contour. With confirmation, the pattern region defined by the contour is assumed to be the image measurement region.

An image region selected by the user can be an image position of a pixel, which is calculated from a contact region of a finger, for instance, or can be a region comprising a number of pixels.

It is also possible for a pattern recognition to be carried out initially automatically with the aid of the image, which can result in one or more pattern regions displayed in the image. The user can now select the desired pattern region which can then be assumed to be the image measurement region by tapping thereon or determining it in another way.

In one development, the user can select the type of definition of the image measurement region, in other words e.g. can toggle between a definition with the aid of a cursor/cursor region and an image pattern recognition. If the user is dissatisfied with the result of the image pattern recognition, for instance, he can switch to a definition with the aid of a cursor/cursor region or vice versa.

In one embodiment, the automatic pattern recognition comprises a pattern matching with a pattern database, in which image patterns associated with predetermined food to be cooked are stored. This further facilitates an automatic determination of a useful pattern region, which matches a specific food to be cooked. For instance, a number of reference patterns associated with a chicken can be stored in the pattern database and the pattern region can be ascertained in the currently recorded image with the aid of or by means of this reference pattern.

In one embodiment, a user-selectable image measurement region is firstly selected automatically and is assumed after a user confirmation or an absence of a user confirmation within a predetermined image duration (which is likewise interpreted as a user confirmation). This can increase user-friendliness. If a user therefore identifies that the automatically selected image measurement region is appropriate, the user can easily confirm this, perform absolutely no action for a predetermined period of time or simply move to the next action step (e.g. entering a degree of browning). The automatic selection of the image measurement region can dispense with the use of complex AI algorithms and represent e.g. the center of the image or a region surrounding the center of the image. If the user is not keen on the automatic selection, he can change the image measurement region as described above, e.g. in respect of its position, shape and/or size.

In one embodiment, the image measurement region is traced automatically during the cooking process. The advantage is therefore achieved that with a change in a position of the food to be cooked and/or its shape, the image measurement region corresponds at least largely to the user-selected image measurement region. The change in position of the food to be cooked can be caused e.g by the user stirring or rotating the food to be cooked. The change in shape may involve dough rising, for instance.

In particular, a process sequence can be carried out as follows:

a user loads food into the cooking chamber, e.g. of an oven;

an image of the cooking chamber which shows the food to be cooked is recorded automatically by means of the oven;

the oven sends the image to a preferably touch-sensitive oven screen and/or to a preferably touch-sensitive screen of a user terminal;

the user defines the image measurement region by tapping or the like on an image region; whereupon from the position of the finger a predetermined (e.g. square or circular) image measurement region is then overlaid onto the image. The image measurement region can be centered e.g. about a pixel position defined during tapping or the like. Alternatively, an image pattern region which comprises the position of the finger on the image can be generated automatically by tapping. Alternatively, an automatically generated image measurement region can be offered to a user, e.g. a square or circular image measurement region e.g. in the center of the image, which only needs to be confirmed by the user;

after defining or ascertaining the image measurement region, it is possible to automatically calculate and display in a basically known manner based on the contents of the image measurement region a scale of browning and the user can set the desired degree of browning with the aid of the scale of browning;

the cooking process is then carried out until the desired degree of browning is reached, which can take place in a basically known manner.

If the user moves the food to be cooked during the cooking process or the food to be cooked moves itself (e.g. dough rises), in one development the movement can be followed by means of an algorithm and the image measurement region traced accordingly. The user does not need to select a new image measurement region.

The object is also achieved by an apparatus which is designed to carry out the method as described above, having:

a household cooking appliance with a cooking chamber,

at least one camera directed into the cooking chamber,

at least one screen, on which recordings captured by the at least one camera can be shown,

at least one operator interface, which is designed to define the user-selectable image measurement region in the displayed image and to ascertain the desired degree of browning, and

a data processing facility which is designed to carry out the cooking process taking into account the desired degree of browning.

The apparatus can be embodied in an analogous manner to the method and has the same advantages.

The household cooking appliance can be an oven, in particular baking oven, microwave appliance, steam treatment appliance or any combination thereof, for instance, e.g. an oven with a microwave and/or a steam treatment functionality.

The camera can be integrated into the household cooking appliance, in particular directed into the cooking chamber through a cooking chamber wall. Alternatively or in addition the camera can be arranged outside of the cooking chamber, e.g. directed into the cooking chamber from the outside through an inspection window of a door closing the cooking chamber. Especially in this case the camera can be a removable camera.

The screen can be a touch-sensitive screen, which enables a particularly simple operation. The user interface is then integrated in particular into the screen or the screen is also used as a user interface.

The screen can however also be a non-touch-sensitive screen, the image measurement region of which can be adjusted by way of a separate operator interface. The operator interface can have for instance control panels (e.g. sensor buttons), e.g. a cursor key cross, a joystick etc. For instance, the non-touch-sensitive screen and the operator interface can assume different regions on a control panel of the household appliance.

The operator interface and the screen can also be referred to together as user interface.

The image can be displayed on a screen or simultaneously on a number of screens.

In one development the camera and the screen are color-coded, i.e. a color camera and a color screen, which makes it particularly easy to determine the image measurement region and ascertain a degree of browning.

In one embodiment, the apparatus is the household cooking appliance. This is advantageous in that the household cooking appliance can carry out the method autonomously and for this purpose does not require, but may have, a connection to a network. In this embodiment, the household cooking appliance has a screen and an operator interface (possibly integrated into a touch-sensitive screen) for carrying out the method, which can represent parts of a control panel. The data processing facility can correspond to a control facility of the cooking appliance or a central control facility of the cooking appliance can also be designed to carry out the method.

In one development, the apparatus is a system which comprises the household cooking appliance as a system component. In one embodiment, the screen and the operator interface are components of a user terminal (e.g. of a smartphone, tablet PC, desktop PC, notebook etc.), and the household cooking appliance has a communication interface for transmitting data relating to the method with the user terminal. This is advantageous in that the image measurement region and the desired degree of browning can be defined or ascertained in a particularly user-friendly manner on a user terminal. In order to carry out the method, a corresponding application program (“app”) can be installed on the user terminal. The household cooking appliance can likewise have or dispense with a screen and the operator interface.

In one embodiment, the pattern database is stored in a network-assisted data memory, e.g. in what is known as the “cloud”. As a result, storage space in the household cooking appliance can be spared.

In one embodiment, the apparatus comprises a network-assisted image processing facility at least for defining the user-selectable image measurement region in the displayed image by means of automatic pattern recognition. However, the automatic pattern recognition can also be carried out by means of the user terminal and/or the household cooking appliance.

If the household cooking appliance has a communication interface for transmitting data relating to the method, it is basically also possible to carry out the method optionally autonomously by means of the household cooking appliance or to execute at least parts thereof in a computer-assisted entity. This may depend for instance on whether or not a user would like to execute the definition of the user-selectable image measurement region on a user terminal. This also includes the case that the definition of the user-selectable image measurement region is performed with the aid of the screen of the household cooking appliance (e.g. for a user to check, change and/or confirm an image measurement region calculated by automatic pattern recognition), but a computing power for automatic pattern recognition as such is carried out by means of a network-assisted image processing facility (e.g. a network server or a cloud computer), possibly with the aid of a network-assisted pattern database.

The above-described properties, features and advantages of this invention and the manner in which these are achieved will become clearer and more readily understandable in connection with the following schematic description of an exemplary embodiment, which will be described in further detail making reference to the drawings.

FIG. 1 shows a possible process flow for operating a household cooking appliance including setting a desired degree of browning;

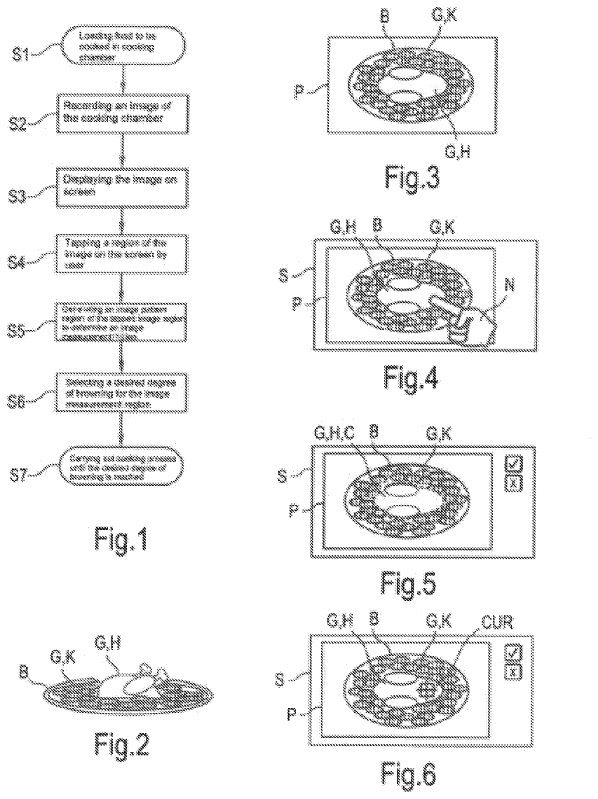

FIG. 2 shows food to be cooked introduced into a cooking chamber of the household cooking appliance;

FIG. 3 shows an image of the food to be cooked, recorded by means of the household cooking appliance, on a touch-sensitive screen;

FIG. 4 shows a first sub-step of a user selecting an image measurement region;

FIG. 5 shows a second sub-step of a user selecting the image measurement region; and

FIG. 6 shows an alternative second sub-step for a user selecting the image measurement region;

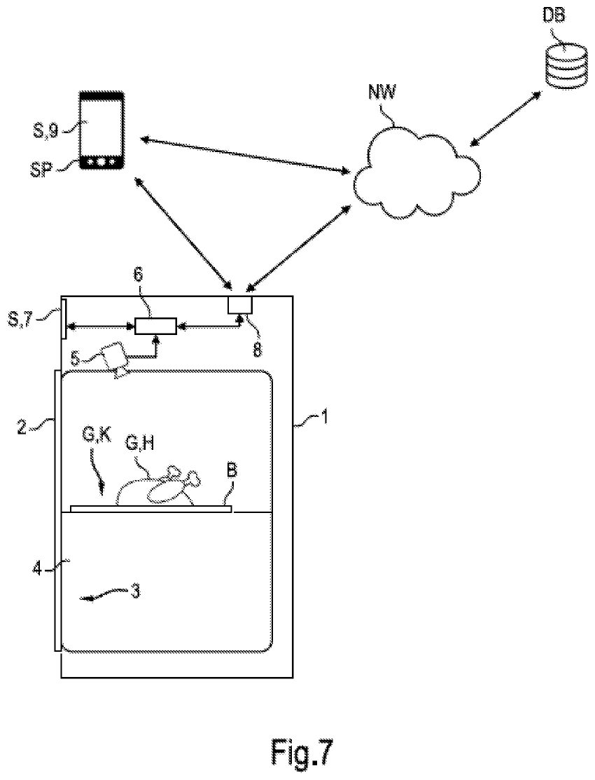

FIG. 7 shows a sectional representation in the side view of a drawing of an apparatus for carrying out the method.

FIG. 1 shows a possible process flow for operating a household cooking appliance in the form of an oven 1 (see FIG. 7), for instance, including setting a desired degree of browning.

In a step S1, a user loads the cooking chamber 2 of the oven 1 with food to be cooked G. The food to be cooked G can, as shown schematically in FIG. 2, comprise a chicken H placed on a colored baking tray B and potato slices K or French fries arranged around it. In order to determine an image measurement region which is suited to high user satisfaction, it is fully automatically only unreliably possible, namely not even possible, if complex AI algorithms are used.

In a step S2, an image P of the cooking chamber 2 is recorded by means of a camera 5 (see FIG. 7) of the oven 1, which here shows the baking tray B, the food to be cooked G and its environment. Such an image P is shown schematically in FIG. 3.

In a step S3, the image P is sent to a touch-sensitive screen S, e.g. a screen 7 of the baking oven 1 and/or a screen 9 of a user terminal such as a smartphone SP (see FIG. 7) and displayed there, as shown schematically in FIG. 4.

As likewise shown in FIG. 4, in a step S4 a user N can tap a region of the screen S, on which the image P is displayed, e.g. with his finger, a pen etc., here an image region which belongs to the chicken H.

An image pattern region is now generated automatically in a step S5 relating to the tapped image region, which is shown with a dashed line as a contour C of the chicken H in FIG. 5. If the image pattern region corresponds to the image measurement region required by the user N, the user N can confirm the image pattern region as the image measurement region, e.g. by tapping an affirmative check box (top check box in FIG. 5) or if not reject it, e.g. by tapping a negative check box (bottom check box in FIG. 5). The image measurement region then corresponds to the confirmed image pattern region C. Alternatively, the user N can place the image measurement region on the potato slices K.

The image pattern region C can be calculated only from the image information contained in the image P. In one variant, a comparison with image patterns stored in a pattern database DB (see FIG. 7), which are assigned to specific foods to be cooked G, can additionally be performed. As a result, the at least one image pattern determined in the image P can approximate the shape of known foods to be cooked in an improved manner. Therefore, the image patterns of chicken H can be stored in the pattern database DB, e.g. varied according to viewing angle, part (e.g. whole chicken, half chicken, drumstick etc.).

In a step S6, a scale of browning (no fig.) is automatically generated for the selected or defined image measurement region and displayed on the screen S. With the aid of the scale of browning the user N can enter or select a desired degree of browning (here of the chicken H). Alternatively, the user N can ascertain the desired degree of browning of the potato slices K.

In a following step S7, a cooking process is carried out by means of the control facility 6 of the baking oven 1, until the desired degree of browning is reached, namely on the basis of a comparison of a current actual degree of browning calculated by means of the image measurement region with the desired degree of browning.

In an alternative step S5, which can be carried out instead of the above-described step S5, a predetermined image region (cursor CUR) is overlaid onto the image P on the screen S. The cursor CUR can be moved by the user N, e.g. by tapping or a drag and drop movement by means of a finger, pen etc. to a point of the image B at which the user N would like to evaluate the degree of browning. The cursor CUR can, as shown in FIG. 6, reproduce the shape and size of the image measurement region, wherein only the position of the cursor CUR still needs to be ascertained by the user N. The image measurement region therefore corresponds here to the image region determined by the cursor CUR. In one variant the user N can adjust the size and/or shape of the cursor CUR and thus also the image measurement region.

In a further variant, the cursor CUR can be confirmed by a user at its starting position (e.g. the image center) on the image P without the cursor CUR needing to be moved.

The confirmation can also take place in that the user does not change the image measurement region C, CUR for a predetermined period of time.

If the user N moves the food to be cooked G during the cooking process, the movement can be followed by means of an image evaluation algorithm, and the image measurement region C, CUR can be traced accordingly or adjusted to the movement. As a result, the user N does not need to select a new image measurement region C, CUR.

FIG. 7 shows as a sectional representation in the side view a drawing of an apparatus 1, SP, DB for carrying out the method. The apparatus comprises a baking oven 1, a user terminal in the form of a smartphone SP and optionally a pattern database DB.

The baking oven 1 has a cooking chamber 2, the front loading opening 3 of which can be closed by means of a door 4. By means of the loading opening 3 the cooking chamber 2 can be loaded with the food to be cooked G which is present in the baking tray B. There is a camera 5 in the region of a ceiling of the cooking chamber 2 which is directed from above or obliquely above into the cooking chamber 2. The camera 5 can optionally be located at another point. A number of cameras 5 may also be present. The camera 5 is connected to a touch-sensitive screen 7 by way of a control facility 6, for instance. Images P recorded by the camera 5 can be sent to this screen 7, whereupon the user N, as described above, can define the image measurement region C, CUR and can also set a desired degree of browning. On the basis of the selected image measurement region C, CUR and the desired degree of browning, the control facility 6 can control a cooking process, (e.g. activate heating elements, not shown), e.g. until the desired degree of browning is reached. In one variant the method can be carried out autonomously on the baking oven 1.

In an alternative or additional second variant, the baking oven 1 can be wirelessly connected to the smartphone SP by way of a communication module 8, e.g. a Bluetooth and/or WLAN module. The smartphone likewise has a touch-sensitive screen 9, by way of which the above method steps S3 to S6 can proceed, namely instead of or in addition to the screen 7 of the baking oven 1.

The baking oven 1 and/or the smartphone 2 can be connected to a pattern database DB way of of a network NW, e.g. the internet.

The present invention is naturally not restricted to the exemplary embodiment shown.

Therefore generally two or even more image measurement regions can also be defined by a user and the same or different browning target values can be assigned to these image measurement regions. The following cooking process can then be terminated for instance if the actual degrees of browning of one or more of the image measurement regions reach the associated desired degree of browning.

In general, “a”, “an”, etc. can be understood as singular or plural, in particular in the sense of “at least one” or “one or more”, etc., provided this is not explicitly excluded, e.g. by the expression “precisely one”, etc.

### LIST OF REFERENCE CHARACTERS

1 Oven
2 Cooking chamber
3 Loading opening
4 Door
5 Camera
6 Control facility
7 Touch-sensitive screen of the oven
8 Communication module
9 Touch-sensitive screen of the smartphone
B Baking tray
C Contour
CUR Cursor
DB Pattern database
G Food to be cooked
H Chicken
K Potato slice
N User
NW Network
P Image of the cooking chamber
S Touch-sensitive screen
S1-S7 Method steps
SP Smartphone

1.-14. (canceled)

15. A method for setting a desired degree of browning of food to be cooked, said method comprising:
recording an image from a cooking chamber of a household cooking appliance containing food to be cooked;
displaying the image on a screen;
defining in the displayed image a user-selectable image measurement region; and
ascertaining a desired degree of browning for the selected image measurement region.

16. The method of claim 15, wherein defining the image measurement region comprises a user-led positioning of the image measurement region over the screen.

17. The method of claim 16, wherein the user-led definition of the image measurement region comprises a touch-led and/or control panel-led positioning of the image measurement region over the screen.

18. The method of claim 15, wherein the image measurement region is defined by:
selecting an image region by the user;
determining automatically a pattern region comprising the image region at the image region; and
assuming the pattern region to be the image measurement region.

19. The method of claim 18, wherein the pattern region is automatically recognized by matching a pattern with a pattern database which stores image patterns associated with predetermined food to be cooked.

20. The method of claim 15, wherein the image measurement region is variable by the user.

21. The method of claim 15, wherein the user-selectable image measurement region is selected automatically, and further comprising assuming the user-selectable image measurement region within a predetermined period of time after a user confirmation or an absence of a user confirmation.

22. The method of claim 15, further comprising automatically tracing the user-selectable image measurement region during a subsequent cooking procedure.

23. The method of claim 15, further comprising setting the desired degree of browning by the user.

24. Apparatus for setting a desired degree of browning of food to be cooked, said apparatus comprising:
a household cooking appliance having a cooking chamber,
a camera directed into the cooking chamber,
a screen for displaying an image recorded by the camera,
an operator interface designed to define a user-selectable image measurement region in the displayed image and to ascertain the desired degree of browning; and
a data processing device designed to carry out a cooking process taking into account the desired degree of browning.

25. The apparatus of claim 24, wherein the apparatus is the household cooking appliance.

26. The apparatus of claim 24, wherein the screen and the operator interface are components of a user terminal, said household appliance including a communication interface for transmitting data relating to the image measurement region and the desired degree of browning with the user terminal

27. The apparatus of claim 24, further comprising a pattern database in which image patterns associated with predetermined food to be cooked are stored and which is stored in a network-assisted data memory.

28. The apparatus of claim 24, further comprising a network-assisted image processing facility designed to define the user-selectable image measurement region in the displayed image through automatic pattern recognition.
